(19) United States
(12) Patent Application Publication
(10) Pub. No.: US 2013/0145674 A1
(43) Pub. Date: Jun. 13, 2013

(54) Trailer Connection and Hook System

(71) Applicant: David Nichols, Tyler, TX (US)

(72) Inventor: David Nichols, Tyler, TX (US)

(21) Appl. No.: 13/314,498

(22) Filed: Dec. 8, 2011

(51) Int. Cl. A01K 85/00

(52) U.S. Cl. 43/42.36

(57) ABSTRACT

Embodiments of the current invention are directed towards an apparatus for connection to dual and multi hook fishing lures. In an embodiment, a single hook can be loaded over dual hooks via the two eye holes. An exemplary embodiment of the present invention may comprise a dual hook, a wire attachment clip, a joining mechanism (including a sleeve, and a plastic spacer according to one embodiment), and a trailer hook. When attached to the dual hook, the trailer hook point or points ride in a position behind and between the dual hook.

### BRIEF DESCRIPTION OF THE DRAWINGS

These and other features, aspects and advantages of the present invention will become better understood with regard to the following description, appended claims, and accompanying drawings where:

FIG. 1 shows an exploded view of a system according to an exemplary embodiment of the present invention;

FIG. 2 shows a perspective view of a wire attachment clip according to an exemplary embodiment of the present invention;

FIG. 3 shows a side view of the system shown in FIG. 1 in an assembled configuration;

FIG. 4 shows a top view of the system shown in FIG. 1 in an assembled configuration;

FIG. 5 shows a perspective view of the system shown in FIG. 1 in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, an exemplary embodiment of the present invention provides a trailer connection and hook system for dual hook or multi hook fishing lures.

Fishermen often need to attach a trailer hook system to dual style hooks to assist in the hooking of short striking fish. This system allows the fisherman to attach a trailer hook to baits with these type of hooks. However, fish hooks come equipped with only one eye hole allowing for attachment to either a single wire or line. Currently there is no product available that can be used to transition a single eye hook to one that allows for attachment to a dual hook. An exemplary embodiment of the present invention can transform the single eye into a dual eye system allowing the single hook to be loaded over dual hooks via the two eye holes. However, a design concept is contemplated by the current invention involving a system for fitting a multi hook fishing lure, using the same design concept as set forth herein.

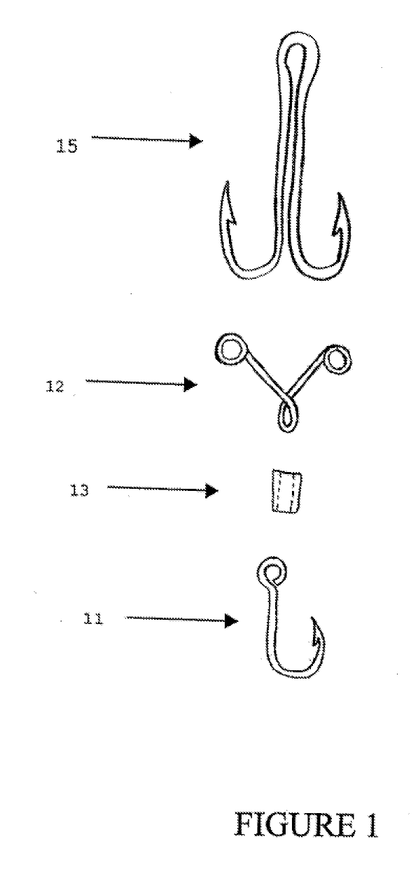

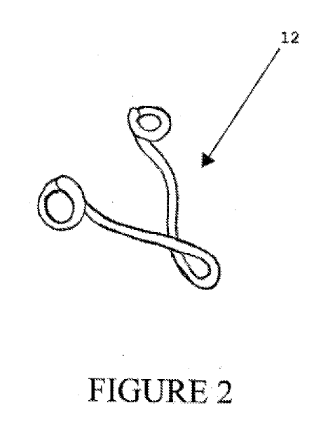

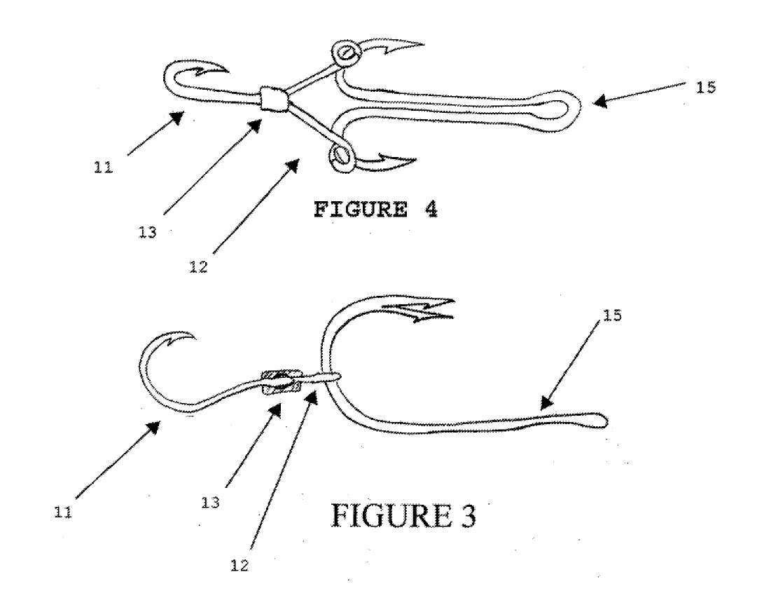

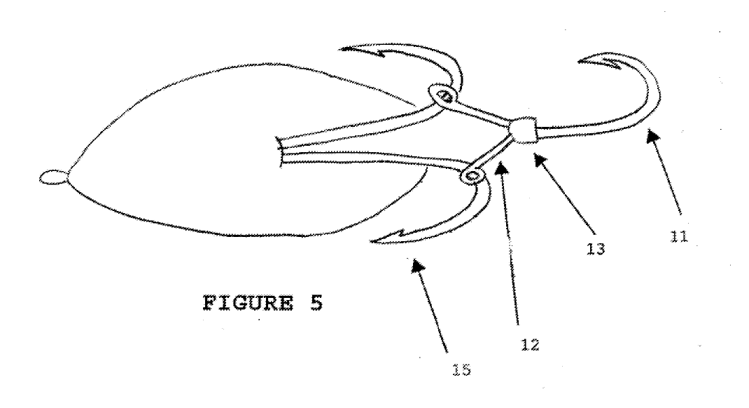

Referring to FIG. 1, an exemplary embodiment of the present invention may comprise a dual hook 15, a wire attachment clip 12, a joining mechanism 13 (including a sleeve, and a plastic spacer in the current embodiment), and a trailer hook 11. The wire attachment clip 12 can be a component which firmly attaches the trailer hook 11 to the dual hook 15. The wire attachment clip 12 of the system can take a substantially “V” shape configuration with a 360 degree loops or oval circles that can fit over the tips of each of the hook points of the dual hook 15. When attached to the dual hook 15, the trailer hook point or points ride in a position behind and between the dual hook. The center loop of the “V” shape clip 12 can be placed thru the eye of any suitable style hook 11 with a single eye loop, which can attach the single hook component to the “V” shaped wire component 12.

In order to secure the connection between the hook 11 and the clip 12, a joining mechanism 13, is required. In the current embodiment, the joining mechanism 13 further comprises a plastic spacer and a sleeve. The plastic spacer can be placed just below the eye on the trailer hook 11. The sleeve can be provided, e.g., a layer of adhesive lined polyolefin or other type heat shrink, which can be placed around the connection area. Heat may be applied causing the shrink to melt along with the adhesive which can bond the trailer hook 11 securely to the clip 12 and over the top of the plastic spacer on the trailer hook 11.

An attachment yoke can be provided to connect to the shafts of the dual hook. A linkage method can be used to secure the trailer hook to the attachment yoke. The wire component can be manufactured out of wire and formed into the proper shape or molded out of plastic with the hook imbedded into the molded part, provided that the design can allow for dual attachment holes to allow for placement over each hook point of the dual hook.

The “V” shaped system may be made to snap onto the shaft of the dual hooks without having to be placed over the hook points. The base of the “V” may be made flexible so as to allow the trailer hook to move and flex if so desired. The wire attachment component can make the physical connection between the trailer hook and the dual hook shafts. The trailer hooks can act a means for hooking the fish.

The plastic spacer on the shaft of the trailer hook can act to fill in any possible void under the adhesive lined heat shrink. The adhesive lined heat shrink can act as tie mechanism between the attachment yoke and the trailer hook.

The clip can be made out of formed wire with the trailer hook. The clip can also be made via injection molding to create a plastic version.

A person can place each of the loops at the top of the “V” shape clip over the hook points or shaft of the dual hook. The clip can be used where a transition is needed from one connection eye hole to a dual eye holes.

It should be understood, of course, that the foregoing relates to exemplary embodiments of the invention and that modifications may be made without departing from the spirit and scope of the invention as set forth in the following claims.

What is claimed is:

1. An apparatus for attachment to a dual hook fishing lure, the apparatus comprising a means for attachment of a dual hook fishing lure to a trailer hook system.

2. The apparatus of claim 1, wherein said means for attachment of a dual hook fishing lure to a trailer hook system includes a solid joining member, said solid joining member having one end for connection to said dual hook fishing lure, and another end for connection to said trailer hook system.

3. The apparatus of claim 2, wherein said solid joining member includes two eye holes at one end for insertion of said dual hook fishing lure, and one eye hole at the other end for insertion of said trailer hook system.

4. The apparatus of claim 3, wherein said eye holes are 360 degree loops or oval circles.

5. The apparatus of claim 3, wherein said solid joining member is a wire attachment clip in a substantially “V” shape configuration.

6. The apparatus of claim 5, wherein said solid joining member is flexible so as to allow a trailer hook to flex if so desired.

7. The apparatus of claim 5 wherein said wire attachment clip may be made to snap onto the shafts of said dual hook fishing lure without having to be placed over the hook points.

8. The apparatus of claim 5, wherein said solid joining member includes a plastic spacer.

9. The apparatus of claim 8, wherein solid joining member is placed just below said eye hole near said trailer system.

10. The apparatus of claim 5, wherein said solid joining member includes a sleeve.

11. The apparatus of claim 10, wherein said sleeve is a layer of adhesive lined polyolefin or heat shrink tubing.

12. The apparatus of claim 11, wherein said sleeve is placed around the area wherein said trailer hook system is joined to said solid joining member.

13. The apparatus of claim 3, wherein said solid joining member is molded from plastic.

14. The apparatus of claim 14, wherein said trailer hook system is imbedded in said solid joining member.

15. The apparatus of claim 3, wherein said solid joining member is constructed of solid wire.

16. The apparatus of claim 3, wherein said trailer hook system is a single hook.

17. The apparatus of claim 16, wherein said single hook is inserted into said single eye hole at one end of said solid joining member.

18. The apparatus of claim 3, wherein said trailer hook system is inserted into said single eye hole at one end of said solid joining member.

19. An apparatus for attachment to a dual-hook fishing lure to a trailer hook system, comprising a solid joining member, wherein said solid joining member has a dual eye system allowing a single hook to be loaded over dual hooks via said dual eye system.

20. An apparatus for attachment to a multi-hook fishing lure to a trailer hook system, comprising a solid joining member, wherein said solid joining member has a multi eye system allowing a single hook to be loaded over a plurality of hooks via said multi eye system.
